(19) United States
(12) Patent Application Publication
(10) Pub. No.: US 2008/0081726 A1
(43) Pub. Date: Apr. 3, 2008

(54) Transfer device having planetary gear-type speed change mechanism

(75) Inventors: Daisuke Saito, Okazaki-shi (JP); Toru Inoue, Obu-shi (JP); Shinji Kitaoka, Tokai-shi (JP); Akinori Homan, Toyota-shi (JP); Satoshi Munakata, Nishikamo-gun (JP)

Correspondence Address: BUCHANAN, INGERSOLL & ROONEY PC, POST OFFICE BOX 1404, ALEXANDRIA, VA, 22313-1404, US

(73) Assignees: AISIN AI CO., LTD, Nishio-shi (JP); TOYOTA JIDOSHA KABUSHIKI KAISHA, Toyota-shi (JP)

(21) Appl. No.: 11/902,777

(22) Filed: Sep. 25, 2007

(30) Foreign Application Priority Data
Sep. 30, 2006 (JP) 2006-270165

(51) Int. Cl. F16H 57/08

(52) U.S. Cl. 475/331

(57) ABSTRACT

A transfer device having a planetary gear-type speed change mechanism includes a transfer case, a planetary gear mechanism having a sun gear, a carrier, a plurality of pinion shafts, a plurality of pinion gears and a ring gear, an input shaft, an output shaft, a clutch hub, a shift sleeve having a first and a second spline, wherein one of engagement between the first spline formed on a shift sleeve and a third spline integrally formed on the sun gear, and engagement between the second spline formed on the shift sleeve and a fourth spline formed on a gear piece integrally formed on the carrier is selectively established, a synchronizer ring having a cone shaped recessed portion and a lug, and an operating member being tilted towards the clutch hub or the synchronizer ring in response to moving direction of the shift sleeve in order to press the synchronizer ring.

### CROSS REFERENCE TO RELATED APPLICATIONS

This application is based on and claims priority under 35 U.S.C. §119 to Japanese Patent Application 2006-270165, filed on Sep. 30, 2006, the entire contents of which is incorporated herein by reference.

### FIELD OF THE INVENTION

The present invention relates to a transfer device that is applied to a four-wheel-drive vehicle and that distributes torque transmitted from a transmission to front and rear wheels. More specifically, the present invention relates to the transfer device including a planetary gear-type speed change mechanism that shifts a gear ratio (speed) between a high-range drive connection and low-range drive connection.

### BACKGROUND

It is recognized that there is a difficulty in changing a gear ratio between a high-range drive connection and a low-range drive connection within a transfer device having a planetary gear-type speed change mechanism. The difficulty in changing the speed ranges is characterized as a difficulty in synchronism, that is difficulty in synchronizing speed of high and low speed drives to rotational speed of an output shaft provided to the transfer device. The difficulty in changing the speed ranges would not be a major concern for a vehicle having a manual transmission. However, the difficulty in changing the speed ranged becomes a major concern for a vehicle having an automatic transmission. Especially when the vehicle having the automatic transmission is temporarily stopped, torque is transmitted to an input shaft provided to the transfer device because of drag torque generated at a torque converter provided to the automatic transmission. Therefore, for the vehicle having the automatic transmission, a smooth control relating to shifting operation between the high-range drive connection and the low-range drive connection has been pursued. An example of transfer devices having planetary gear-type speed change mechanism is disclosed in JP1998196770A. The known art disclosed in JP1998196770A includes a brake band provided along a surface of a brake friction material that is provided near a planet carrier. In order to achieve a smooth shifting between the high-range drive connection and the low-range drive connection, in JP1998196770A, an actuator controls the brake band in order to engage the brake band with the surface of the brake friction material. However, a structure of the known art disclosed in JP1998196770A is complicated because a brake device, the actuator and a control device for controlling the actuator need to be provided to the transfer device. As a result, manufacturing costs of the transfer device disclosed in JP1998196770A may be increased.

A structure of a transfer device illustrated in FIG. 4 is conceivable in order to simplify the configuration of the transfer device disclosed in JP1998196770A and to lower the manufacturing costs of the transfer device of the known art. The transfer device having a planetary gear-type speed change mechanism includes a transfer case 1 to which a planetary gear mechanism 5 is provided. The planetary gear mechanism 5 includes a carrier 6, a sun gear 7, pinion gears 9 supported by the carrier 6 and a ring gear 8. An input shaft 2 is coaxially and integrally formed with the sun gear 7. An output shaft 3 is rotatably and coaxially fixed to the sun gear 7 so as to be selectively connected to either the sun gear 7 or the carrier 6 via a shifting mechanism 10. The carrier 6, which is rotatably supported within the transfer case 1, includes a first extension 6a at a side of the input shaft 2 and a second extension 6b at a side of the output shaft 3. The first axial extension 6a and the second axial extension 6b are integrally connected with each other at several points thereof in a circumferential direction of the carrier 6 by connecting portions 6d. One end of each pinion shafts 6c is supported by the first extension 6a. The other end of each pinion shafts 6c is supported by the second extension 6b. Further, the pinion shafts 6c are provided between each connecting portions 6d in the circumferential direction of the carrier 6. Each of the pinion gears 9 is rotatably supported at each of the pinion shafts 6c. The sun gear 7 is provided coaxially with the carrier 6 between the first extension 6a and the second extension 6b so as to be rotatable. The sun gear 7 is engaged with each of the pinion gears 9. The ring gear 8, which is fixed on the transfer case 1 so as to be coaxial with the sun gear 7, is also engaged with each of the pinion gears 9. The sun gear 7 includes a boss portion projecting to the right in FIG. 4 in parallel to the output shaft 3. A first internal spline 14 is formed on an outer circumferential surface of the boss portion. A conical surface 15 is formed on an end portion of the boss portion. A gear piece 13 fixed to the second extension 6b includes a second internal spline 13a that is formed to be coaxial with the sun gear 7.

A clutch hub 11 is fixed on the output shaft 3. Further, the clutch hub 11 is provided at the right side of the conical surface 15 in FIG. 4 in the axial direction of the output shaft 3. A shift sleeve 12 is splined to the clutch hub 11 on its outer circumferential periphery. The shift sleeve 12 includes a first internal spline 12a and a second external spline 12b. The shift sleeve 12 is moved in the axial direction of the output shaft 12 in order to selectively engage the first internal spline 12a with the first external spline 14 formed on the sun gear 7, or the second external 12b with the second internal spline 13a formed on the gear piece. The second external spline 12b is formed on one end portion of the shift sleeve 12 facing the sun gear 7. An annular groove 12c is formed on an outer circumferential portion of the other end portion of the shift sleeve 12. An end portion of a shift fork 19 (not shown) is slidably engaged with the annular groove 12c with retaining a slight clearance therebetween. A base end portion of the shift fork 19 is fixed to a shift rail 18. When the shift rail 18 is slid in an axial direction thereof, the shift sleeve 12 is also slid in the axial direction of the shift rail 18. The upper half of FIG. 4 shows a state within the transfer device where a low-range drive connection is established. When the low-range drive connection is established, as shown in the upper half of FIG. 4, the shift sleeve 12 is shifted to the right in order to engage the second external spline 12b formed on the shift sleeve 12 with the second internal spline 13a formed on the gear piece. As a result, the carrier 6, which is fixed to the gear piece 13, is connected to the output shaft 3. The lower half of FIG. 4 shows a state where a high-range drive connection is established within the transfer device. When the high-range drive connection is established, as shown in the lower half of FIG. 4, the shift sleeve 12 is shifted to the left in order to engage the first internal spline 12a formed on the shift sleeve 12 with the first external spline 14 formed on the sun gear 7. As a result, the sun gear 7 is connected to the output shaft 3.

In this configuration, a synchronizer ring 16 is provided between the sun gear 7 and the boss portion of the clutch hub 11. The synchronizer ring 16 includes a cone-shaped hole that is frictionally engageable with the conical surface 15 formed on the end portion of the boss portion, and an external spline that is engageable with the first internal spline 12a formed on the shift sleeve 12. Further, a plurality of synchronizer keys 17 is provided on the clutch hub 11. Specifically, the plurality of synchronizer keys 17 is supported at groove portions formed on the outer circumferential periphery of the clutch hub 11 so as to move in the axial and a circumferential direction of the clutch hub 11. Further, the plurality of synchronizer keys 17 is elastically engaged with recessed portions formed in a trapezoidal cross-sectional shape. Each of the recessed portions is formed on a middle portion of an inner surface of the shift sleeve 12 in the axial direction thereof. The conical surface 15, the synchronizer ring 16 and the synchronizer keys 17 constitute a so-called Borg-Warner type synchromesh in which rotation of the sun gear 7 and rotation of the output shaft 3 are synchronized when the first external spline 14 formed on the sun gear 7 is engaged with the first internal spline 12a formed on the shift sleeve 12 in order to establish the high-range drive connection.

The configuration of the transfer device illustrated in FIG. 4 is simpler than that of JP1998196770A. Therefore, the manufacturing costs of the transfer device illustrated in FIG. 4 may be lower than that of JP1998196770A. However, depending on operational conditions, noise is generated by gears during a gear speed shifting operation. A speed shifting operation will be explained below.

The speed shifting operation is conducted when rotation of the output shaft 3 is stopped. In the transfer device having the planetary gear-type speed change mechanism shown in FIG. 4, when the gear ratio is shifted from the low-range drive connection to the high-range drive connection, firstly, the shift sleeve 12 is moved to the left in FIG. 4, and secondly the second external spline 12b formed on the shift sleeve 12 is disengaged from the second internal spline 13a formed on the gear piece 13. Then the first internal spline 12a formed on the shift sleeve 12 is engaged with the first external spline 14 formed on the sun gear 7 in order to establish the high-range drive connection. In this case, rotation of the sun gear 7 and the rotation of the output shaft 3 are synchronized by an operation of the Borg-Warner type synchromesh that includes the conical surface 15, the synchronizer ring 16 and the synchronizer keys 17. Therefore, even when the transfer device is applied to an automatic transmission and even when the drag torque is applied to the input shaft 2, the rotation of the sun gear 7 is stopped because the rotational speed of the sun gear 7 is synchronized with the rotational speed of the output shaft 3 whose rotation is stopped. As a result, a noise may not be generated by the gears when the first internal spline 12 of the shift sleeve 12 is engaged with the first external spline 14 of the sun gear 7.

On the other hand, when the gear ratio is shifted from the high-range drive connection to the-low range drive connection, firstly, the shift sleeve 12 is moved to the right in FIG. 4, and secondly the first internal spline 12a formed on the shift sleeve 12 is disengaged from the first external spline 14 formed on the sun gear 7. Then finally, the external spline 12b formed on the shift sleeve 12 is engaged with the second internal spline 13a formed on the gear piece 13. In this case, in a process when the first internal spline 12a being disengaged from the first external spline 14 and then the external spline 12b being engaged with the second internal spline 13a, the sun gear 7 and the carrier 6 are still rotated because of the drag torque applied to the input shaft 2 even when the rotation of the output shaft 3, which is connected to objective wheels to be driven, is stopped. Further, in this case, the second internal spline 13a of the gear piece 13, which is rotated in conjunction with the carrier 6, is engaged with the second external spline 12b of the shift sleeve 12, whose rotation is spotted. As a result, the noise may not be generated by the gears.

In order to lower the noise generated by the gears, it is conceivable to provide another Borg-Warner type synchromesh between the second external spline 12b formed on the shift sleeve 12 and the second internal spline 13a formed on the gear piece 13. However, there is no sufficient space for another Borg-Warner type synchromesh to be provided within the transfer device whose configuration is illustrated in FIG. 4. Hence, a need exists to provide a transfer device having the planetary gear-type speed change mechanism which is not susceptible to the drawback mentioned above.

### SUMMARY OF THE INVENTION

A transfer device having a planetary gear-type speed change mechanism includes a transfer case, a planetary gear mechanism having a sun gear and a carrier that are rotatably supported at the transfer case and being coaxial with each other, the sun gear including a boss portion projecting in an axial direction thereof, and a conical surface formed on one end portion of the boss portion, a diameter of the conical surface is decreased in one direction, a plurality of pinion shafts provided at the carrier in a circumferential direction of the sun gear, a plurality of pinion gears rotatably supported by the plurality of pinion shafts along a circumferential surface of the sun gear and being engaged with the sun gear, and a ring gear fixed to the transfer case so as to be coaxial with the sun gear and being engaged with the plurality of pinion gears, an input shaft transmitting rotational speed to the sun gear, an output shaft supported at the transfer case so as to be rotatable and coaxial with the sun gear, a clutch hub coaxially fixed to the output shaft with retaining a space from the conical surface of the sun gear in the axial direction of the output shaft, notch grooves being formed on the clutch hub, a shift sleeve, which is supported on the outer circumferential portion of the clutch hub so as to be slidable in the axial direction of the output shaft, having a first spline and a second spline, wherein the first spline is engageable with a third spline integrally formed on the sun gear, and the second spline is engageable with a fourth spline formed on a gear piece integrally formed on the carrier, wherein one of the engagement between the first spline and the third spline and the engagement between the second spline and the fourth spline is selectively established, a synchronizer ring having a cone shaped recessed portion with which the conical surface of the sun gear is frictionally engage, the synchronizer ring having a lug projecting from a portion of an inner circumferential periphery of the synchronizer ring in an axial direction of the output shaft, and an operating member provided between the clutch hub and the synchronizer ring for pressing the synchronizer ring in response to movement of the shift sleeve in order to frictionally engage the conical surface of the sun gear with the cone shaped recessed portion of the synchronizer ring, the operating member including a half-circular shaped portion straddling the output shaft and a key portion outwardly projecting from a central portion of the half-circular shaped portion, the operating member being rotated in conjunction with rotation of the clutch hub and being movable in a radial direction and tiltable relative to the output shaft, wherein both end portions of the operating member contacts the lug in order to rotate the synchronizer ring, the operating member is tilted towards the clutch hub and the synchronizer ring in response to moving direction of the shift sleeve, and wherein the operating member presses the synchronizer ring so that the cone shaped recessed portion of the synchronizer ring is engaged with the conical surface of the boss portion formed on the sun gear, even when the operating member is tilted towards the clutch hub or the synchronizer ring.

### BRIEF DESCRIPTION OF THE DRAWINGS

The foregoing and additional features and characteristics of the present invention will become more apparent from the following detailed description considered with the reference to the accompanying drawings, wherein:

FIG. 1 illustrates a cross-sectional diagram that shows relevant parts of a transfer device having planetary gear-type speed change mechanism relating to an embodiment of the present invention;

FIG. 2 illustrates a cross-sectional diagram of a shifting mechanism taken along line II-II of FIG. 1;

FIG. 3A, FIG. 3B and FIG. 3C illustrate operations of the transfer device related to the embodiment shown in FIG. 1; and

FIG. 4 illustrates a cross-sectional diagram that shows an example of transfer devices having planetary gear-type speed change mechanism related to the known art.

### DETAILED DESCRIPTION

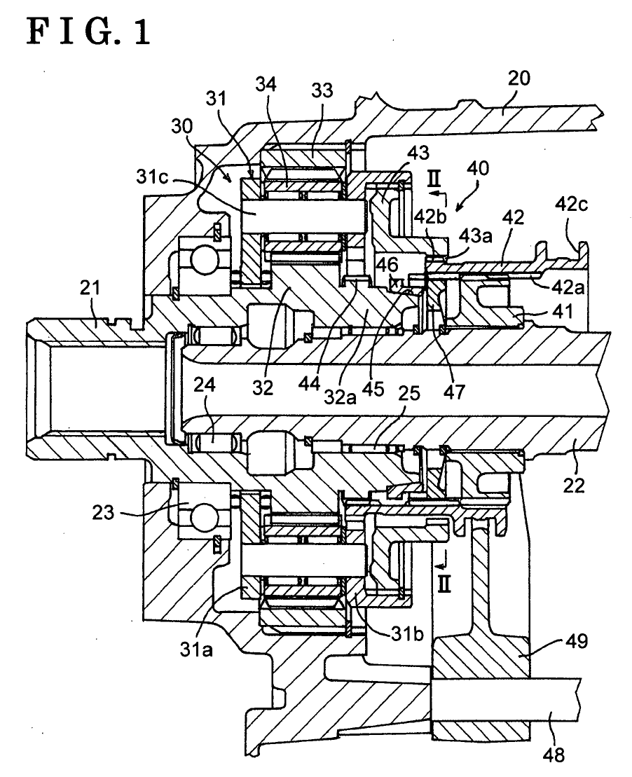

An embodiment of the present invention will be explained in accordance with FIGS. 1 through 3 of the attached drawings. As shown in FIG. 1, a transfer device having the planetary gear-type speed change mechanism includes a planetary gear mechanism 30, an input shaft 21, an output shaft 22, a shifting mechanism 40 and a transfer case 20. The planetary gear mechanism 30 includes a carrier 31, a sun gear 32, a plurality of pinion gears 34 supported by the carrier 31 and a ring gear 33. The input shaft 21 is integrally and coaxially formed with the sun gear 32. The output shaft 22 is provided to the transfer case 20 so as to be rotatable and coaxial relative to the sun gear 32, and further the output shaft 22 extends in an opposite direction from a direction in which the input shaft 21 extends. The shifting mechanism 40 selectively connects the carrier 31 or the sun gear 32 to the output shaft 22. The transfer case 20 houses the planetary gear mechanism 30, the shifting mechanism 40, input shaft and the output shaft 22 except for end portions of the input shaft 21 and the output shaft 22. The output shaft 22 is connected to front and rear wheels to be driven via a distributing mechanism (not shown).

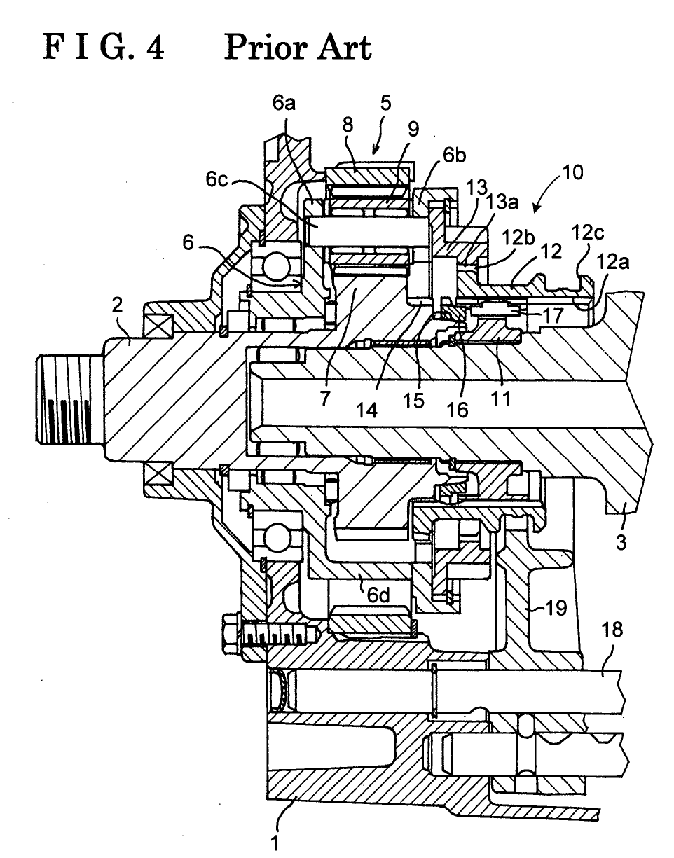

The input shaft 21 is rotatably supported by the transfer case 20 via ball bearings. An end portion of the output shaft 22, which is coaxially arranged with the input shaft 21, is supported by the input shaft 21 via roller bearings 24. As with the carrier 6 explained in accordance with FIG. 4, the carrier 31 of the planetary gear mechanism 30 includes a first extension 31a and a second extension 31b. The first extension 31a and the second extension 31b are integrally connected with each other at several points of the first and the second axial extensions 31a and 31b via connecting portions (not shown) in a circumferential direction of the carrier 31. Further, the carrier 31 is rotatably supported at the transfer case 20 so as to be coaxially rotatable with the input shaft 21. The sun gear 32 is arranged between the first axial extension 31a and the second axial extension 31b. Each of pinion shafts 31c is provided between each of the connecting portions and along a circumferential surface of the sun gear 32 so as to extend in the axial direction thereof. On end portion of each of the pinion shafts 31c is press-fitted to the first extension 31a and the other end portion of each of the pinion shafts 31c is press-fitted to the second extension 31b in order to support each of the pinion shafts 31c by the first and the second extensions 31a and 31b. Each of the pinion gears 34, which is engaged with the sun gear 32, is rotatably supported by each of the pinion shafts 31c by means of needle bearings (not shown). The ring gear 33 is fixed to the transfer case 20 so as to be coaxial with the sun gear 32. The ring gear 33 is engaged with each of the pinion gears 34 at an inner surface of the ring gear 33 facing the sun gear 32. A boss portion 32a is integrally formed at the sun gear 32. Specifically, the boss portion 32a projects from the sun gear 32 to the right in an axial direction of the output shaft 22 in FIG. 1. A base portion, which is integrally connected and extends to the sun gear 32, and an end portion, which is positioned opposite from the base potion, are formed on the boss portion 32a. A first external spline 44 (third spline) is formed on a circumferential surface of the base portion of the boss portion 32a. A conical surface 45 is formed on the end portion of the boss portion 32a. An end diameter of the conical surface 45 at the right side in FIG. 1 is formed to be smaller than the other end diameter facing the sun gear 32. The first external spline 44 and the conical surface 45 are included to the shifting mechanism 40 whose constitution will be explained below. A plurality of needle bearings 25 is provided between an inner surface of the boss portion 32a and the output shaft 22. The inner surface of the boss portion 32a faces an outer circumferential surface of the output shaft 22.

As shown in FIGS. 1 through 3, the shifting mechanism 40 includes a clutch hub 41 fixed to the output shaft 22, a shift sleeve 42, a gear piece 43, a synchronizer ring 46, a pair of levers 47 (operating member), the first external spline 44 and the conical surface 45. Hereinafter, one of the levers 47 is referred to as an upper lever 47 and the other of levers 47 is referred to as a lower lever 47. The clutch hub 41 is securely fixed on an outer surface of the output shaft 22 by spline-engaging the clutch hub 41 with the output shaft 22. A cylinder potion, which coaxially extends in both direction of the output shaft 22, is formed on an outer circumferential portion of the clutch hub 41. A cylindrical portion 41a projects from the cylinder portion and extends to the side of the sun gear 32. A pair of notch grooves 41a1, which has a constant width, is formed on the cylindrical portion 41a in order to hold a pair of key portions 47b so as to be movable, the key portions 47b being formed on each of the upper and the lower levers 47. An external spline 41b is formed on an outer circumferential periphery of the cylinder portion formed on the clutch hub 41 and extending in both direction of the axial direction of the output shaft 22. A first internal spline 42a (first spline) is formed along an entire length of an inner circumferential surface of the shift sleeve 42 in a cylindrical shape. The shift sleeve 42 is slidably supported by the external spline 41b via the first internal spline 42a so that the shift sleeve 42 freely slides in the axial direction thereof. Recessed portions 42a1 in a trapezoidal cross sectional shapes are formed at a central portion in the axial direction of the first external spline 42a. Further, the recessed portions 42a1 are formed on an inner circumferential surface of the first external spline 42a, and the recessed portions 42a1 extending in a circumferential direction of the first external spline 42a. An end portion of the first internal spline 42a at the side of the sun gear 32 is engageable with the first external spline 44 formed on the boss portion 32a of the sun gear 32. A second external spline 42b (second spline) is formed on an end portion, facing the sun gear 32, of an outer circumferential surface of the shift sleeve 42. An annular groove 42c is formed at the other end portion of the shift sleeve 42 at its outer circumferential surface.

By spline-engaging the gear peace 43 with the second extension 31b of the carrier 31, the gear piece 43 is securely fixed to an inner surface of the second axial extension 31b facing the outer circumferential surface of the output shaft 22 and extending in parallel with the output shaft 22. A cylindrical portion is integrally formed on the gear piece 43 and extends in the axial direction of the output shaft 22. A second internal spline 43a (fourth spline) is formed on an end portion of an inner circumferential surface of the cylindrical portion of the gear piece 43. The second internal spline 43a is formed so as to be engageable with the second external spline 42b formed on the shift sleeve 42. An end portion (not shown) of a shift fork 49 is freely slidably engaged at the annular groove 42c with retaining a slight clearance therebetween. A base end portion of the shift fork 49 is fixed on the shift rail 48. The shift sleeve 42 is slid in the axial direction thereof by sliding the shift rail 48 in the axial direction thereof in order to selectively establish engagement between the end portion of the first internal spline 42a formed on the shift sleeve 42 and the first external spline 44 formed on the boss portion 32a of the sun gear 32, or engagement between the second external spline 42b formed on the shift sleeve 42 with the second internal spline 43a formed on the gear piece 43.

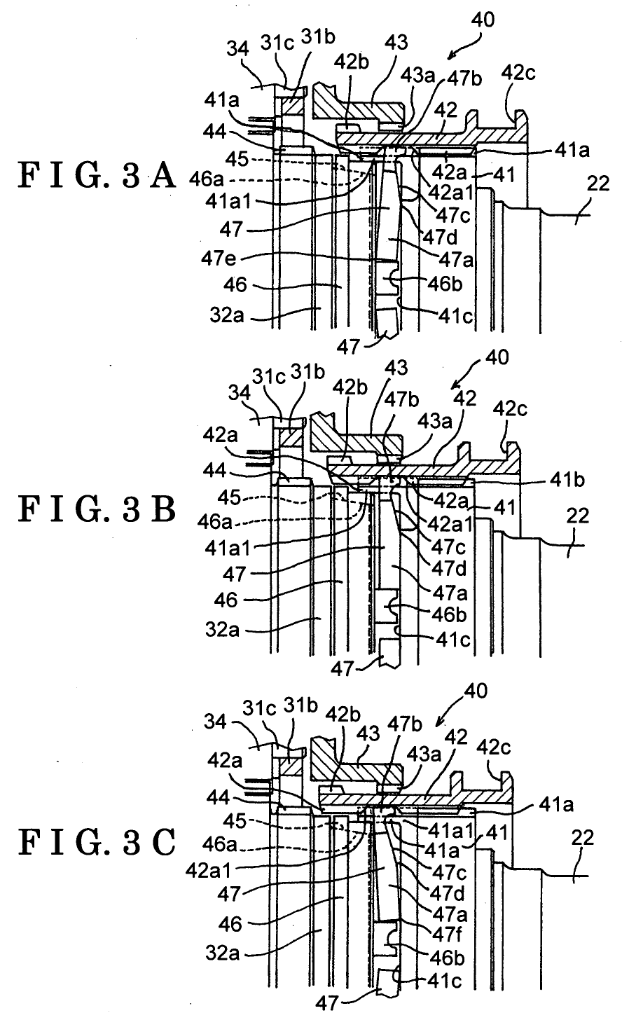

The synchronizer ring 46 includes a cone shaped recessed portion 46a at which the synchronizer ring 46 is frictionally engaged with the conical surface 45 formed on the sun gear 32. A flange is formed on an outer circumferential surface of an end portion of the synchronizer ring 46. The flange of the synchronizer ring 46 is positioned between an end of the cylindrical portion 41a of the clutch hub 41 and the boss portion 32a of the sun gear 32 so that the synchronizer ring 46 moves a slight distance therebetween. When the conical surface 45 is frictionally engaged with the cone shaped recessed portion 46a, an end surface formed on a base portion of the synchronizer ring 46, which is opposite from the one end portion having the flange, is positioned at the right of an end surface of the conical surface 45 of the sun gear 32. A pair of lugs 46b projects to the right in FIG. 3 from the end surface of the synchronizer ring 46 in the axial direction of the output shaft 22, and further the pair of lugs 46b is provided at an opposed position with each other on a circumference of the synchronizer ring 46 in a radial direction thereof. An outer diameter of the flange formed on the synchronizer ring 46 is slightly smaller than an inner diameter of the first internal spline 42a formed on the shift sleeve 42.

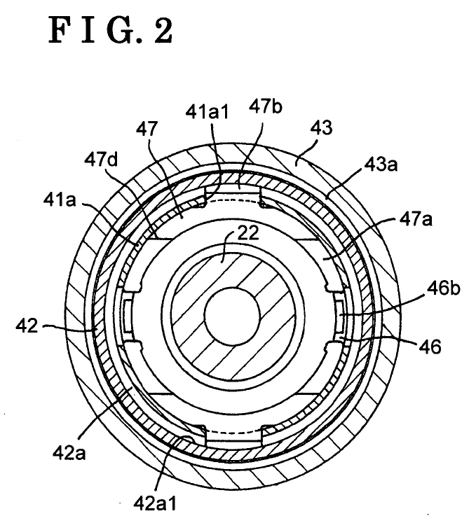

As shown in FIGS. 1 through 3, each of the upper and the lower levers 47 is movably provided between the clutch hub 41 and the synchronizer ring 46 so that one surface of each of the upper and the lower levers 47 contacts an end surface 41c of the clutch hub 41 facing the synchronizer ring 46. As well-illustrated in FIG. 2, each of the upper and the lower levers 47 is integrally formed with a half-ring shaped portion 47a (half-circular portion), which straddles the output shaft 22, and the key portion 47b having a constant width and projecting outwardly from a top (central portion) of the half-ring shaped portion 47a formed on each of the upper and the lower levers 47. Each of the upper and the lower levers 47 is basically formed with a constant thickness. However, as illustrated in FIG. 3, a notch portion 47c is formed between the key portion 47b and the surface of the semicircle-shaped portion 47a at which each of the upper and the lower levers 47 contacts the end surface 41c of the clutch hub 41. The notch portion 47c is formed so as to extend in parallel with both ends of leg portions of the semicircle-shaped portion 47a. Further, the notch portion 47c has a constant cross-section shape. An inclined surface is formed from the deepest portion of the notch portion 47c towards an end of the semicircle-shaped portion 47a formed on the surface of each of the upper and the lower levers 47. An arris line 47d (middle portion) is formed on each of the upper and the lower levers 47 at a position where the inclined surface crosses the surface of each of the upper and the lower levers 47 contacting the end surface 41c of the clutch hub 41. Further, the arris line 47d formed on each of the upper and the lower levers 47 run along the middle line between the leg portions and the key portion 47b in parallel with the both ends of leg portions of the semicircle-shaped portion 47a.

Each of the upper and the lower levers 47 includes the semicircle-shaped portion 47a, which straddles the output shaft 22 and the key potion 47b that is slidably supported at the notch groove 41a1 formed on the cylindrical portion 41a of the clutch hub 41. Further, each of the upper and the lower levers 47 is positioned between the clutch hub 41 and the synchronizer ring 46 so as to be movable in a radial direction thereof and tiltable relative to the output shaft 22. Each of the pair of the lugs 46b formed on the synchronizer ring 46 is positioned between, for example, an end of the leg portion of the upper lever 47 and an end of the leg portion of the lower lever 47 facing the end of the leg portion of the upper lever. Therefore, when the upper and the lower levers 47 are rotated in conjunction with rotation of the clutch hub 41 fixed on the output shaft 22, the synchronizer ring 46 is also rotated via the pair of lugs 46b. Each of the upper and the lower levers 47 is outwardly biased in radial direction of the shift sleeve 42 by means of springs (not shown). Further, each of the upper and the lower levers 47 is pressed to the end surface 41c of the clutch hub 41 by means of springs (not shown) that are provided between the synchronizer ring 46 and the levers 47.

Hereinafter, operation of the transfer device in the above-mentioned embodiment of the present invention will be explained in detail. Shifting operation of the gear ratio between high-range drive connection and the low-range drive connection is conducted by shifting mechanism 40 under the condition where a vehicle is stopped, and then the rotation of the output shaft 22 is also stopped. When neither of the high-range drive connection nor the low-range drive connection is established, the transfer case output remains at neutral in which neither the engagement between the first internal spline 42a of the shift sleeve 42 with the first external spline 44 of the sun gear 32, nor the engagement between the second external spline 42b of the shift sleeve 42 with the second internal spline 43a of the gear piece 43 is established. When the transfer case output remains at neutral, as shown in FIG. 2 and FIG. 3B, each of the upper and the lower levers 47 is moved outwardly in the radial direction thereof. Then the key portion 47d, which is formed on each of the upper and the lower levers 47 and which is freely slidably supported within the notch groove 41a1 of the cylindrical portion 41a of the clutch hub 41, is engaged at the recessed portion 42a1 that is formed on the central portion of the first internal spline 42a of the shift sleeve 42.

When the shift sleeve 42 is shifted to the right in FIG. 1 (first direction) from the neutral position by means of the shift fork 49 in order to establish the low-range drive connection, as shown in FIG. 3A, each of the upper and the lower levers 47 presses the synchronizer ring 46 so that the cone shaped recessed portion 46a is frictionally engaged with the conical surface 45 of the boss portion 32a in a manner where: firstly, the key portion 47b, which is formed on each of the upper and the lower levers 47 so as to be engaged at the recessed portion 42a1, is moved to the right in conjunction with the sliding movement of the shift sleeve 42; secondly, each of the upper and the lower levers 47 is tilted relative to the arris line 47a as a fulcrum, the arris line 47a running along the middle line of each of the semicircle-shaped portions 47a in parallel with the output shaft 22; and finally one end portion 47e, which is formed on a surface of each of the semicircle-shaped portions 47a facing the synchronizer ring 46, contacting a part of an end surface of the synchronizer ring 46 in the vicinity of each of lugs 46b. As the one end portion 47e formed on each of the upper and the lower levers 47 presses the synchronizer ring 46, even when an automatic transmission is mounted to the vehicle, therefore, even when drag torque is applied to the input shaft 21, the rotation of the sun gear 32 is synchronized with that of the rotation of the output shaft 22. Accordingly, as mentioned above, the rotation of the output shaft 22 is stopped, and the rotation of the carrier 31 and the gear piece 43 are also stopped.

When the shift sleeve 42 is further moved to the right from the above-mentioned state, engagement between the second external spline 42b formed on the left side of the outer circumferential surface of the shift sleeve 42 in FIG. 1 and the second internal spline 43a formed on the gear piece 43 is started. However, as the rotation of the output shaft 22 and the gear piece 42 are stopped, the noise is not generated by gears. When the shift sleeve 42 is further moved to the right, the engagement between the second external spline 42b formed on the shift sleeve 42 and the second internal spline 43a formed on the gear piece 43 is further advanced. At the same time, the key portion 47b formed on each of the upper and the lower levers 47 moves upon an inclined surface of the recessed portion 42a1, and then disengagement between the key portion 47b of each of the upper and the lower levers 47 and the recessed portion 42a1 formed on the first internal spline 42a of the gear piece 42 is started. When the shift sleeve 42 is moved to further right and exceeds a predefined position, the key portion 47b formed on each of the upper and the lower levers 47 moves on the inclined surface of the recessed portion 42a1, and the key portions 47b is completely disengaged from the recessed portion 42a1. As a result, pressure that each of the upper and lower levers 47 applies to the synchronizer ring 46 is eliminated. When the shift sleeve 42 is further moved to the right, the engagement between the second external spline 42b formed on the shift sleeve 42 and the second internal spline 43a formed on the gear piece 43 is further advanced. As a result, the shifting operation to establish the low-range drive connection is completed as shown in an upper half of FIG. 1. Therefore, according to the embodiment of the transfer device having planetary gear-type speed change mechanism, the noise is not generated while the low-rage drive connection is being established.

On the other hand, when the shift sleeve 42 is moved to the left in FIG. 1 (second direction) from the neutral position by means of the shift fork 49 in order to establish the high-range drive connection, as shown in FIG. 3C, each of the upper and the lower levers 47 presses the synchronizer ring 46 so that the cone shaped recessed portion 46a is frictionally engaged with the conical surface 45 of the boss portion 32a in a manner where: firstly, the key portion 47b, which is formed on each of the upper and the lower levers 47 so as to be engaged at the recessed portion 42a1, is moved to the left; secondly, each of the upper and the lower levers 47 is tilted relative to the other end portion 47f as a fulcrum, and the other end portion 47f is a point where leg portions of each of the upper and the lower levers 47 contacting the end surface 41c of the clutch hub 41; and finally, a part of the key portion 47b facing the synchronizer ring 46 contacts a part of an edge portion of the outer circumferential periphery of the synchronizer ring 46. As with the case where the low-range drive connection is established from neutral, even when the drag torque is applied to the input shaft 21, the rotation of the sun gear 32 is synchronized with the rotation of the output shaft 22 via each of the upper and the lower levers 47 and the synchronizer ring 46 because the synchronizer ring 46 is pressed by each of the upper and the lower levers 47. As the rotation of the output shaft 22 is stopped, so is the rotation of the sun gear 32.

When the shift sleeve 42 is further moved to the left from the above-mentioned state, engagement between the first internal spline 42a facing the output shaft and the first external spline 44 formed on the sun gear 44 is started. As the rotation of the output shaft 22 and sun gear 32 are both stopped, the noise is not generated when the engagement between the first internal spline 42a and the first external spline 44 is started. When the shift sleeve 42 is further moved to the left in the same manner as the case of establishing the low-range drive connection, the engagement between the first internal spline 42a formed on the inner circumferential surface of the shift sleeve 42 and the first external spline 44 formed on the sun gear 32 is further enhanced advanced. At the same time, the key portion 47b formed on each of the upper and the lower levers 47 moves upon the another inclined surface of the recessed portion 42a1, and then disengagement between the key portion 47b of each of the upper and the lower levers 47 and the recessed portion 42a1 formed on the first internal spline 42a of the gear piece 42 is began. When the shift sleeve 42 is moved to further left, the key portion 47b formed on each of the upper and the lower levers 47 moves on the inclined surface of the recessed portion 42a1, and the disengagement between the key portions 47b and the recessed portion 42a1 is completed. As a result, pressure each of the upper and lower levers 47 applies to the synchronizer ring 46 is eliminated. When the shift sleeve 42 is further moved to the left, the engagement between the first internal spline 42a of the shift sleeve 42 and the first external spline 44 of the sun gear 32 is further advanced. As a result, the shifting operation for establishing the high-range drive connection is completed as shown in a lower half of FIG. 1. Therefore, according to the embodiment of the transfer device having planetary gear-type speed change mechanism, the noise is not generated at the gears while establishing the high-rage drive connection.

According to the embodiment of the present invention, each of the upper and the lower levers 47, which presses the synchronizer ring 46 in conjunction with sliding movement of the shift sleeve 42, includes the half-ring shaped portion 47a, which straddles the output shaft 22, and the key portion 47b projecting outwardly from the top of the half-ring shaped portion 47a so as to be freely slidably engaged with each of the notch portions 47c formed on the cylindrical portion 41a of the clutch hub 41. Further, each of the upper and the lower levers 47 is rotated in conjunction with the rotation of the clutch hub 41. Also, each of the upper and the lower levers 47 is tiltable and movable in the radial direction relative to the output shaft 22. The synchronizer ring 46 is rotated by each of the upper and the lower levers 47 via each of the lugs 46b that projects from a part of the synchronizer ring 46 in the axial direction of the output shaft 22. Each of the upper and the lower levers 47 is tilted in both directions towards the clutch hub 41 and the synchronizer ring 46 in response to the movement of the shift sleeve 42. Each of the upper and the lower levers 47 presses the synchronizer ring 46 so that the cone shaped recessed portion 46a is frictionally engaged with the conical surface 45 of the boss portion 32a formed on the sun gear 32 in any case the levers 47 are tilted toward the clutch hub 41 or the synchronizer ring 46. Therefore, the rotation of the output shaft 22 and the rotation of the sun gear 32 are synchronized because the synchronizer ring 46 is rotated in conjunction with the rotation of the clutch hub 47 fixed on the output shaft 22. At the same time, because the cone-shaped recessed portion 46a of the synchronizer ring 46 is frictionally engaged with the conical surface 45 of the sun gear 32 in any case each of the upper and the lower levers 47 tilted in either of the axial direction of the output shaft 22. The shifting operation of the gear ratio within the transfer device is conducted when the output shaft 22, which is connected to objective wheels to be driven, is stopped. Therefore, when the shifting operation of the gear ration is conducted, both rotation of the sun gear 32 and the carrier 31 are stopped. As a result, the shifting operation of the gear ratio is conducted when rotation of any rotation of the sun gear 32, the shift sleeve 42 provided to the output shaft 22 and the gear piece 43 provided to the carrier 31 are stopped. Hence, the noise is not generated by the gears in any case where the high-range and the low-range drive connections are established.

According to the embodiment of the present invention, when neither of the high-range drive connection nor the low-range drive connection is established, the transfer case output remains at neutral in which neither the engagement between the first internal spline 42a of the shift sleeve 42 and the first external spline 44 of the sun gear 32, nor the engagement between the second external spline 42b of the shift sleeve 42 and the second internal spline 43a of the gear piece 43 is not established. When the transfer case output remains at neutral, each of the upper and the lower levers 47 is moved outwardly in the radial direction thereof. Then, the key portion 47a, which is formed on each of the upper and the lower levers 47, is engaged at the recessed portion 42a1 that is formed on the central portion of the first internal spline 42a of the shift sleeve 42. When the shift sleeve 42 is shifted to one or the other direction of the axial direction of the output shaft 22 from neutral position in order to establish either the high-range drive connection or the low-range drive connection, each of the key portions 47b, which is formed on each of the upper and the lower levers 47, is also moved to the right or the left in FIG. 1 depending on the direction the shift sleeve 42 is moved, and then each of the upper and the lower levers 47 is tilted. After the shift sleeve 42 is moved further than the predefined position, each of the upper and the lower levers 47 is tilted inwardly towards the outer circumferential surface of the output shaft 22 in order to disengage the key portion 47b formed on each of the upper and the lower levers 47 from each of the notch grooves 41a1. According to the embodiment that has the above-mentioned operation, while the key portion 47b formed on each of the upper and the lower levers 47 is engaged at the recessed portion 42a1 formed on the inner surface of the first internal spline 42a of the shift sleeve 42, and while each of the upper and the lower levers 47 is tilted, any rotation of the sun gear 32, the shift sleeve 42 and the gear piece 43 are stopped. Therefore, in any case where the high-range drive connection or the low-range drive connection is established, either the engagement between the first internal spline 42a of the shift sleeve 42 and the first external spline 44 of the sun gear 32 for establishing the high-range drive connection, or the engagement between the second external spline 42b of the shift sleeve 42 and the second internal spline 43a of the gear piece 43 for establishing the low-range drive connection is started without generating the noise at the gears. Then, the shift sleeve 42 is further moved under a condition where the key portion 47b formed on each of the upper and the lower levers 47 is disengaged from the recessed portion 42a1 formed on the shift sleeve 42 in order to complete the engagement between the second external spline 42b of the shift sleeve 42 and the second internal spline 43a of the gear piece 43 for establishing the low-range drive connection.

According to the embodiment of the present invention, when the shift sleeve is moved towards the sun gear 32 from the neutral position in the axial direction of the output shaft 22 in order to establish the high-range drive connection, each of the upper and the lower levers 47 is tilted relative to the other end portion 47f as the fulcrum. The other end portion 47f indicates the portion where the surface of the half-ring shaped portion 47a contacts the end surface of the clutch hub 41. The part of the key portion 47b facing the synchronizer ring 46 contacts the part of the outer circumferential periphery of the synchronizer ring 46. As a result, each of the upper and the lower levers 47 presses the synchronizer ring 46 so that the cone shaped recessed portion 46a is frictionally engaged with the conical surface 45 of the boss portion 32a. When the shift sleeve is moved from the neutral position to the opposite direction to the sun gear 32 in order to establish the low-range drive connection, each of the upper and the lower levers 47 is tilted relative to the arris line 47a running across the middle of each of the half-ring shaped portions 47a contacting the end surface 47f of the clutch hub 41. Then the end portion 47e, which is formed on each of the upper and the lower levers 47, contacts the part of the end surface of the synchronizer ring 46 so that each of the upper and the lower levers 47 presses the synchronizer ring 46. As a result, the cone shaped recessed portion 46a is frictionally engaged with the conical surface 45 of the boss portion 32a. In any case where either the high-range drive connection or the low-range drive connection is established, either the engagement between the first internal spline 42a of the shift sleeve 42 and the first external spline 44 of the sun gear 32 for establishing the high-range drive connection, or the engagement between the second external spline 42b of the shift sleeve 42 and the second internal spline 43a of the gear piece 43 for establishing the low-range drive connection is started without generating the noise at the gears. Then, either engagements between the first internal spline 42a of the shift sleeve 42 and the first external spline 44 of the sun gear 32 for establishing the high-range drive connection, or the engagement between the second external spline 42b of the shift sleeve 42 and the second internal spline 43a of the gear piece 43 for establishing the low-range drive connection is completed, and shifting operation of the gear ratio is also completed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A transfer device having a planetary gear-type speed change mechanism, comprising:
a transfer case;
a planetary gear mechanism including
a sun gear and a carrier that are rotatably supported at the transfer case and being coaxial with each other, the sun gear including a boss portion projecting in an axial direction thereof, and a conical surface formed on one end portion of the boss portion, a diameter of the conical surface is decreased in one direction,
a plurality of pinion shafts provided at the carrier in a circumferential direction of the sun gear,
a plurality of pinion gears rotatably supported by the plurality of pinion shafts along a circumferential surface of the sun gear and being engaged with the sun gear, and
a ring gear fixed to the transfer case so as to be coaxial with the sun gear and being engaged with the plurality of pinion gears;
an input shaft transmitting rotational speed to the sun gear;
an output shaft supported at the transfer case so as to be rotatable and coaxial with the sun gear;
a clutch hub coaxially fixed to the output shaft with retaining a space from the conical surface of the sun gear in the axial direction of the output shaft, notch grooves being formed on the clutch hub;
a shift sleeve, which is supported on the outer circumferential portion of the clutch hub so as to be slidable in the axial direction of the output shaft, having a first spline and a second spline, wherein the first spline is engageable with a third spline integrally formed on the sun gear, and the second spline is engageable with a fourth spline formed on a gear piece integrally formed on the carrier, wherein one of the engagement between the first spline and the third spline and the engagement between the second spline and the fourth spline is selectively established;
a synchronizer ring having a cone shaped recessed portion with which the conical surface of the sun gear is frictionally engage, the synchronizer ring having a lug projecting from a portion of an inner circumferential periphery of the synchronizer ring in an axial direction of the output shaft; and
an operating member provided between the clutch hub and the synchronizer ring for pressing the synchronizer ring in response to movement of the shift sleeve in order to frictionally engage the conical surface of the sun gear with the cone shaped recessed portion of the synchronizer ring, the operating member including a half-circular shaped portion straddling the output shaft and a key portion outwardly projecting from a central portion of the half-circular shaped portion, the operating member being rotated in conjunction with rotation of the clutch hub and being movable in a radial direction and tiltable relative to the output shaft, wherein both end portions of the operating member contacts the lug in order to rotate the synchronizer ring, the operating member is tilted towards the clutch hub and the synchronizer ring in response to moving direction of the shift sleeve, and wherein the operating member presses the synchronizer ring so that the cone shaped recessed portion of the synchronizer ring is engaged with the conical surface of the boss portion formed on the sun gear, even when the operating member is tilted towards the clutch hub or the synchronizer ring.

2. The transfer device having the planetary gear-type speed change mechanism according to claim 1, wherein, when the transfer device remains at neutral in which both the engagement between the first spline formed on the shift sleeve and the third spline formed on the sun gear, and the engagement between the second spline formed on the shift sleeve and the fourth spline formed on the gear piece are not established, the operating member is moved outwardly in a radial direction thereof so that the key portion formed on the operating member is engaged with a recessed portion formed on a central portion of an inner surface of the shift sleeve in the axial direction thereof, the inner surface facing the output shaft, and when the shift sleeve at a neutral position is moved in one of a first or a second axial direction along an axis of the shift sleeve, the key portion formed on the operating member is moved in the one of the first and the second, then the operating member is tilted, and after the shift sleeve is further moved and then moving distance of the shift sleeve exceeds a predetermined amount of distance, the operating member is moved inwardly in a radial direction thereof so that the key portion is disengaged from the recessed portion formed on the shift sleeve.

3. The transfer device having the planetary gear-type speed change mechanism according to claim 1, wherein, when the shift sleeve at the neutral position is moved in the first direction opposite to the sun gear, the operating member is tilted relative to a middle portion, which is set as fulcrum, the middle portion being formed on the surface contacting an end surface of the clutch hub and running across the middle between the leg portions of the half-circular shaped portion and the key portion, then an end portion of the half-circular shaped portion of the operating member facing the synchronizer ring contacts the synchronizer ring and presses the synchronizer ring for frictionally engaging the conical surface formed on the boss portion with the cone-shape recessed portion formed on the synchronizer ring, and when the shift sleeve at the neutral position is moved in the second direction towards the sun gear, the operating member is tilted relative to an other end portion, which is set as fulcrums, the other end portion being formed on surface of the half-circular shaped portion and contacting the end surface of the clutch hub, then parts of surface of the key portion facing the synchronizer ring presses the synchronizer ring for frictionally engaging the cone shaped recessed portion formed on the synchronizer ring with the conical surface of the boss portion.

4. The transfer device having the planetary gear-type speed change mechanism according to claim 2, wherein, when the shift sleeve at the neutral position is moved in the first direction opposite to the sun gear, the operating member is tilted relative to a middle portion, which is set as fulcrum, the middle portion being formed on the surface contacting an end surface of the clutch hub and running across the middle between the leg portions of the half-circular shaped portion and the key portion, then an end portion of the half-circular shaped portion of the operating member facing the synchronizer ring contacts the synchronizer ring and presses the synchronizer ring for frictionally engaging the conical surface formed on the boss portion with the cone-shape recessed portion formed on the synchronizer ring, and when the shift sleeve at the neutral position is moved in the second direction towards the sun gear, the operating member is tilted relative to an other end portion, which is set as fulcrums, the other end portion being formed on surface of the half-circular shaped portion and contacting the end surface of the clutch hub, then parts of surface of the key portion facing the synchronizer ring presses the synchronizer ring for frictionally engaging the cone shaped recessed portion formed on the synchronizer ring with the conical surface of the boss portion.
